(19) United States
(12) Patent Application Publication
(10) Pub. No.: US 2008/0076088 A1
(43) Pub. Date: Mar. 27, 2008

(54) Chemiluminescent saliva ejector

(76) Inventor: James S. Brown, Tuckahoe, NY (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/524,547

(22) Filed: Sep. 21, 2006

(51) Int. Cl. A61C 17/06; A61C 3/00

(52) U.S. Cl. 433/91; 433/29

(57) ABSTRACT

The present application relates to a chemiluminescent saliva ejector. The chemiluminescent saliva ejector includes a first tube and a second tube positioned concentrically within the first tube: leaving a space between the first and second tube. The chemiluminescent saliva ejector also includes a deformable partition separating the space into a first chamber and second chamber, where chemiluminescent components are contained. Upon deformation of the deformable partition, the chemiluminescent components mix to produce luminescence.

### BACKGROUND OF THE INVENTION

1. Field of the Invention

This invention relates to a chemiluminescent device. More specifically, this invention relates to a chemiluminescent saliva ejector, which illuminates a patient's mouth during a dental procedure.

2. Description of the Related Art

During oral procedures, a dentist encounters many obstacles. The oral cavity is a small, dark space that can become filled with blood, saliva, other liquids and debris during a procedure. To alleviate the waste problem, a device known as a saliva ejector is commonly used to suction liquid and debris from the oral cavity of a patient. For example, U.S. Pat. No. 6,821,118, which is incorporated by reference in its entirety, describes a saliva ejector that allows complete suctioning of unwanted saliva buildup in a patient's mouth.

The use of equipment during dental procedures in combination with a dentist's own hands and the small opening of a patient's mouth, renders illumination of the interior of the oral cavity difficult. Adequately lighting the oral cavity remains an issue that has not been satisfactorily resolved.

Typically, an exterior light is directed towards the patient's mouth from above the dental chair. The amount of light entering the mouth, however, is substantially blocked by the dentist's hands and/or the equipment. Adequate lighting is essential for performing dental procedures. Because of the close proximity of the dentist to the patient's mouth, it is very difficult to alleviate the light obstruction from an outside light source.

Generally, devices that exist to illuminate the mouth have extending light fixtures that can further crowd the oral cavity. For example, U.S. Pat. No. 2,161,151 describes a saliva ejector that is adapted to have a lighting element affixed to the outside of the mouthpiece. The lighting fixture protrudes from the saliva ejector creating an obstacle for the dentist to maneuver around.

Despite the known devices implemented for lighting an oral cavity, a less cumbersome alternative may be beneficial. Incorporating a lighting device into an instrument that is already used in dental procedure may be advantageous to illuminating an oral cavity.

### BRIEF SUMMARY OF THE INVENTION

One embodiment of the invention relates to a dental appliance which includes an exterior wall formed from a light transmitting material and a light source contained within the exterior wall where the light source is activated by a user.

Another embodiment of the current invention is a saliva ejector which includes a first tube and a second tube, the second tube positioned within the first tube with a space defined by the inner diameter of the first tube and the outer diameter of the second tube; a deformable partition separating the space into a first chamber and a second chamber; a first chemiluminescent component contained in the first chamber; and a second chemiluminescent component contained in the second chamber where, upon deformation of the deformable partition, the first and second chemiluminescent components mix to produce luminescence.

Yet another embodiment of the present invention relates to a method for illuminating an oral cavity. The method includes bending a chemiluminescent saliva ejector, thereby deforming a deformable partition; mixing a first and second chemiluminescent component to produce luminescence; and inserting the chemiluminescent saliva ejector into an oral cavity to illuminate the oral cavity.

The present invention also relates to a chemiluminescent saliva ejector including an exterior tube having a first end adapted to receive a suctioning tip and a second end adapted to receive a vacuuming attachment, the exterior tube having a plurality of indentations on an inner surface; a container positioned within the exterior tube, suctioning channels defined by an outer surface of the container and the indentations on the inner surface of the exterior tube.

Yet another embodiment of the present invention is a chemiluminescent saliva ejector having a container disposed in a first end of a tube, where the container includes a first compartment and a second compartment, and a first chemiluminescent component contained in the first compartment and a second chemiluminescent component contained in the second compartment, where upon bending of the container the chemiluminescent components mix to produce luminescence.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

For the purposes of illustrating the invention, the drawings show a form of the invention that is presently preferred. However, it should be understood that the present invention is not limited to the precise arrangements and instrumentalities shown in the drawings, wherein:

FIG. 1 shows an enlarged elevation of a suctioning portion of a saliva ejector;

FIG. 2 shows a side elevation of a saliva ejector in a straight position;

FIG. 3 shows a side elevation of a saliva ejector in the bent position;

FIG. 4 shows an enlarged view of a container component of a saliva ejector;

FIG. 5 shows an enlarged view of a container component of a saliva ejector;

FIG. 6 shows an exploded view of one embodiment of a saliva ejector;

FIG. 7 shows one embodiment of a saliva ejector in a straight position;

FIG. 8 shows a cross-sectional view of a saliva ejector taken at section 8-8 of FIG. 7;

FIG. 9 shows an enlarged side view of one embodiment of a saliva ejector;

FIG. 10 shows a longitudinal cross-sectional view of the tip of a saliva ejector; AND

FIG. 11 shows a partial view of an activated saliva ejector.

Like reference numbers and designations in the various drawings indicate like elements.

### DETAILED DESCRIPTION OF THE INVENTION

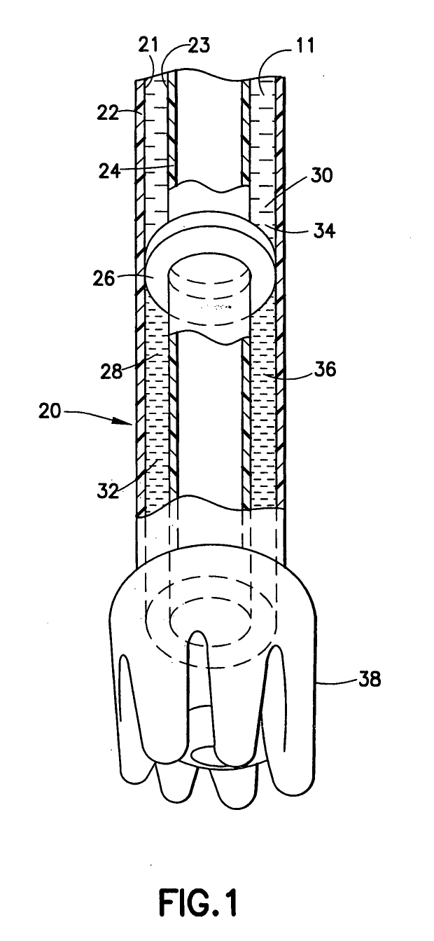

Referring now to FIGS. 1-6 in which like reference numerals indicate like parts, and in particular, to FIG. 1, one aspect of the present invention is a saliva ejector 20 having a first tube 22 and a second tube 24, a deformable partition 26 creating a first chamber 28 and a second chamber 30 in the space between the first tube and the second tube. First chamber 28 contains a first chemiluminescent component 32 and second chamber 30 contains a second chemiluminescent component 34.

First tube 22 and second tube 24 can be constructed of any plastic or polymer material commonly used in the field. It is preferable for second tube 24 to be made with a material of equal flexibility to that of first tube 22. The plastic or polymer should be flexible to permit first tube 22 and second tube 24 to be bent in any suitable form and maintain that form. For example, a semi-rigid Polyvinyl Chloride (“PVC”) material can be used with an internal bendable metal wire incorporated into first tube 22 for nearly its entire length. The metal wire provides for retention of the bent shape to comfortably fit the mouth of the patient during the dental procedure.

Additionally, first tube 22 should be made of a light transmitting material, to allow light emitted from the mixed chemiluminescent component 32 and chemiluminescent component 34 to be visible. Polyethylene, polypropylene, polycarbonate or any other light transmitting material known in the art can be used for first tube 22. When selecting the material, it is important to take into consideration the use of plasticizers or other additives that may affect the chemiluminescent components contained therein. Second tube 24, which is the interior tube, may be constructed of the same material as first tube 22, but it is not necessary for the second tube to be light transmitting.

Saliva ejector 20 should have a diameter in the range between about 0.25 inches to about 0.375 inches, which is standard for dental equipment of this type to avoid being cumbersome in the patient's mouth. First tube 22 typically should have a diameter between about 0.25 inches to about 0.375 inches. Second tube 24 will have a slightly smaller outer diameter between about 0.1 inches to about 0.125 inches and an inner diameter between about 3 millimeters to about 5 millimeters. Second tube 24 will be used as a channel for suctioning. Therefore, the diameter of second tube 24 should be large enough to allow for sufficient suctioning of saliva and other debris through saliva ejector 20.

The inner surface 21 of first tube 22 and the outer surface 23 of second tube 24 are aligned with one another and create space 36 between the first and second tube. Space 36 is divided into at least two chambers, first chamber 28 and second chamber 30, by deformable partition 26. The term “deformable” is understood to mean: easily crushed, broken, bent, shifted, able to be slid or moved in any fashion. Deformable partition 26 can be made of any deformable material known in the art, including, but not limited to glass, plastic, etc.

Deformable partition 26 typically divides first chamber 28 and second chamber 30 into generally equal portions. Deformable partition 26 is placed around second tube 24 and therefore does not block or prevent any suctioning capability. Typically, both first chamber 28 and second chamber 30 are located in a portion of saliva ejector 20 that enters a patient's mouth. A first chemiluminescent component 32 is stored in first chamber 28 and a second chemiluminescent component 34 is stored in second chamber 30. The chemiluminescent components are separately contained in their respective chambers by deformable partition 26.

The chemiluminescent components can be any commercially available nontoxic chemicals that when mixed generate luminescence. Nontoxic chemiluminescent chemicals are well known in the art. For example, either chemiluminescent component 32 or chemiluminescent component 34 can be phenyl oxalate ester solution while the other chemiluminescent component can be hydrogen peroxide. Examples of other chemiluminescent components are listed in U.S. Pat. No. 3,597,362, which is incorporated by reference in its entirety herein. Fluorescent dyes may be added to the chemiluminescent components to create a colored luminescence. Any other combination of chemiluminescent materials known in the art can be incorporated wherein when first chemiluminescent component 32 contacts second chemiluminescent component 34, a chemical reaction occurs producing luminescence.

When saliva ejector 20 is to be used, deformable partition 26 is deformed and first chemiluminescent component 32 and second chemiluminescent component 34 contact each other causing a chemical reaction. Slight shaking of saliva ejector 20 can aid in the mixing of the chemicals. As shown specifically in FIG. 3, the ensuing chemical reaction emits luminescence 40, which is a light visible to the user.

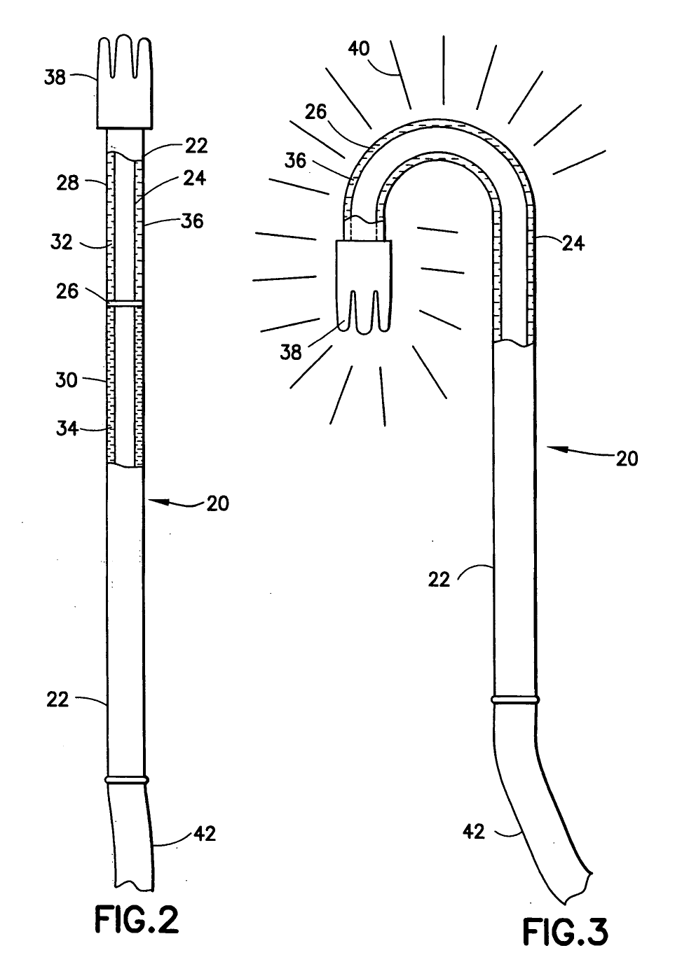

As shown in FIGS. 1-3, one end of saliva ejector 20 is adapted to have a suctioning tip 38 affixed thereto, for insertion into a patient's mouth. Suctioning tip 38 is one generally used in the dentistry practice. Now referring more particularly to FIGS. 2 and 3, the second, or lower end, of saliva ejector 20 is connected to a vacuum line 42.

Still referring to FIG. 2, saliva ejector 20 is typically delivered from the manufacturer in a straight, unbent form. As shown in FIG. 3, saliva ejector 20 may be removed from its sterile packaging and bent into any suitable position when it is to be used by the dentist. Typically, saliva ejector 20 is manipulated into a U shape, but can be bent in any desired position.

Providing a U-shaped bend allows saliva ejector 20 to be placed in a manner which provides suctioning tip 38 to enter the patient's mouth, with the balance of the saliva ejector depending downwardly from the patient's mouth. Bending saliva ejector 20 causes deformable partition 26 in space 36 to become deformed and allows the chemiluminescent components 32 and 34 to mix. Slight shaking of saliva ejector 20 may aid in the mixing of the components aiding in the speed of the chemical reaction. As the chemicals are mixed and react they produce luminescence 40. Once positioned in the patient's mouth, luminescence 40 lights the entire mouth of the patient without the addition of extra equipment.

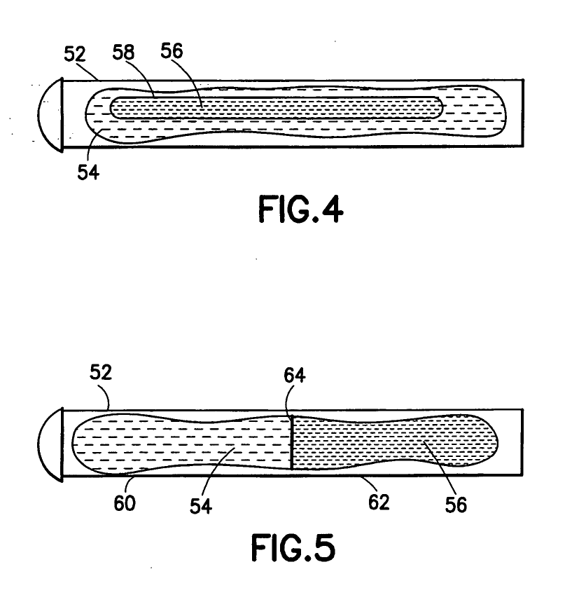

Another embodiment of the present invention is shown in FIGS. 4-7. In this embodiment, the chemiluminescent components are placed in a container 52 that can be removed from saliva ejector 50. Container 52 can be made from any flexible, light-transmitting plastic or polymer known in the art as disclosed above. Container 52 has a diameter which is in the range between about 0.25 inches to about 0.375 inches. In one embodiment, container 52 has a vial 58 positioned inside the container. As shown particularly in FIG. 4, in one embodiment of container 52, a first chemiluminescent component 54 is placed within a first compartment namely, the container. A second chemiluminescent component 56 is placed in a second compartment, namely vial 58. First and second chemiluminescent components 54 and 56 can be the same as discussed above. Vial 58 is typically made of glass but can be made of a breakable plastic or like material. Vial 58 can be attached to the wall of container 52 or can float within the container.

In another embodiment of container 52, as shown in FIG. 5, container 52 can be separated into a first compartment 60 and a second component 62 by a deformable partition 64. Deformable partition 64 can be made of any deformable material known in the art as described above. First chemiluminescent component 54 is stored in first compartment 60 and a second chemiluminescent component 56 is stored in second compartment 62.

Referring now to FIGS. 4 and 5, when the user bends saliva ejector 50, vial 58 breaks or deformable partition 64 deforms causing first chemiluminescent component 54 and second chemiluminescent component 56 to contact each other and mix in container 52 and generate luminescence.

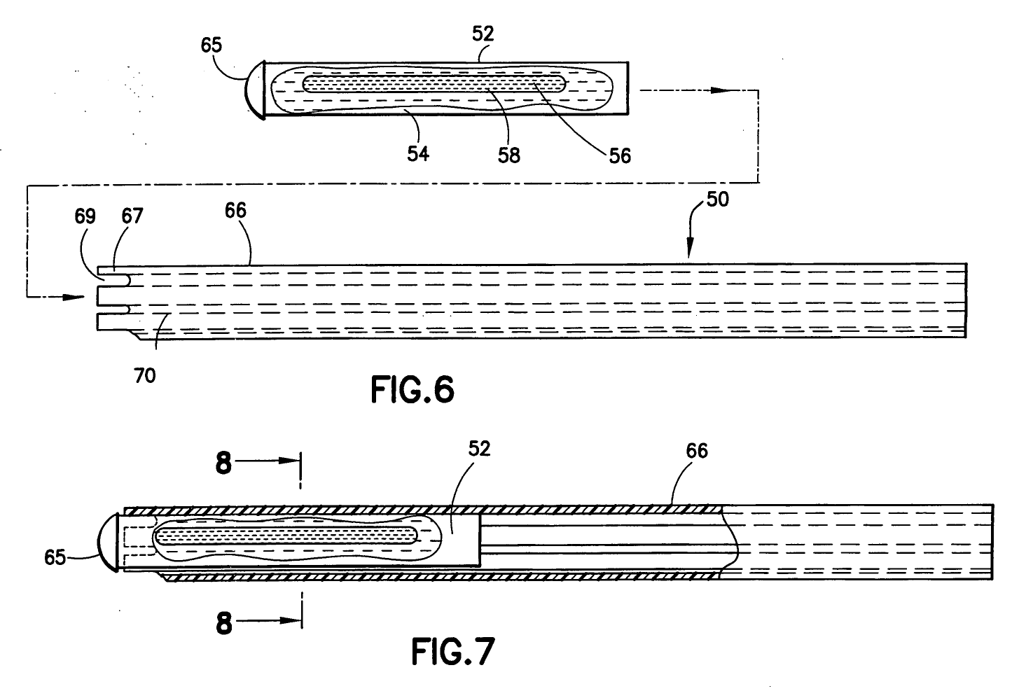

Now referring to FIGS. 6 and 7, saliva ejector 50 is shown in an unbent position. Referring specifically to FIG. 6, container 52 is shown unassembled being aligned with a tube 66. Tube 66 has substantially the same inside diameter as the outside diameter of container 52 and is made from a material that has substantially the same flexibility of the container and is light-transmitting. At first end 67 of tube 66 is a plurality of cut-outs 69 that allow for saliva to enter suctioning channels 70.

Referring now to FIG. 7, saliva ejector 50 is shown assembled. Container 52 is inserted into tube 66 and is secured in place with end portion 65. End portion 65 is made of a similar material as container 52 and tube 66, and is also light-transmitting. End portion 65 has a slightly larger diameter than container 52, thereby forcing the container to remain in the upper portion of tube 66. Because end portion 65 is made from a light-transmitting material, it can be used as a flashlight. As a dentist is performing work in the oral cavity, he often moves the saliva ejector around to spot suction. With a glowing tip on the saliva ejector, the dentist can move the saliva ejector around to also aid as a spotlight.

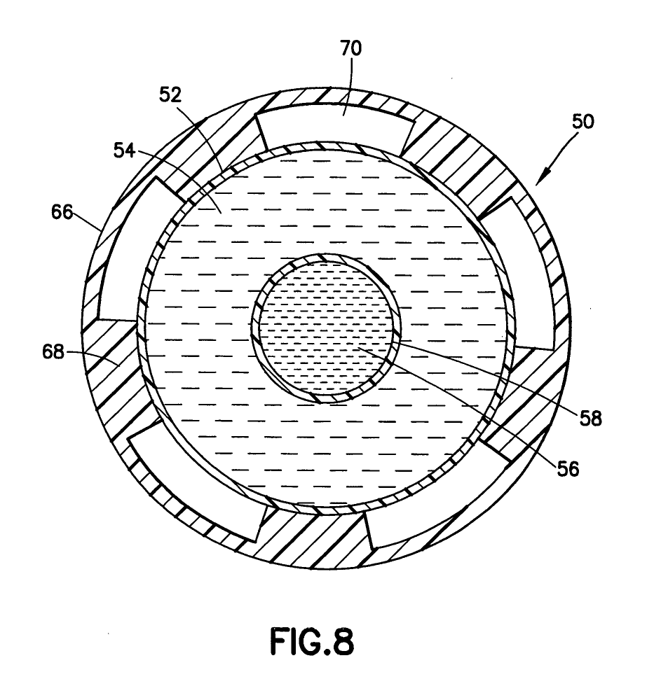

FIG. 8 shows an enlarged cross-sectional view of an assembled saliva ejector 50 taken at section 8-8 of FIG. 7. Referring now to FIG. 8, tube 66 is designed with a plurality of indentations 68 on its inner surface that run parallel to tube 66. Typically, indentations 68 are at least the same length as container 52. It is contemplated that the indentations can be placed on either the inner surface of tube 66, or the outer surface space of container 52, or some combination thereof. When container 52 is inserted into tube 66, indentations 68 create a plurality of suctioning channels 70. In FIG. 8, suctioning channels 70 are enclosed on three sides by tube 66 and on the forth side by container 52. Suctioning channels 70 allow for saliva to pass through tube 66 to an attached vacuuming source (not shown). While FIGS. 6-8 show an embodiment of container 52 containing vial 58, it is also contemplated that deformable partition 64 (FIG. 5) can alternatively be used.

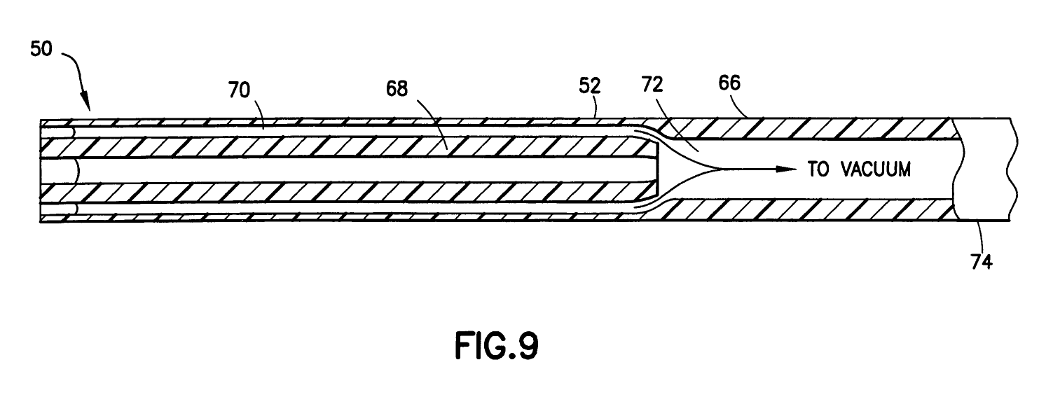

FIG. 9 shows suctioning channels 70 merging together to form one larger suctioning channel 72 where container 52 ends. As saliva enters tube 66 it travels through suctioning channels 70 to larger suctioning channel 72 where the saliva exits saliva ejector 50 via vacuuming attachment 74.

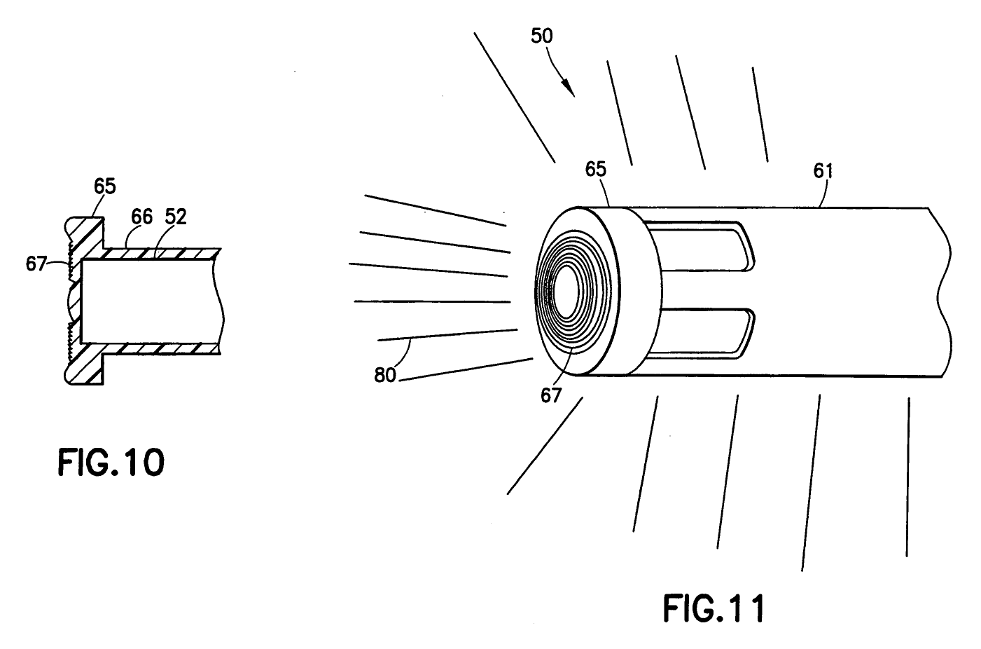

As shown in FIGS. 10 and 11, a Fresnel lens 67 can be incorporated into end portion 65 for better focusing of the light emitted from the tip of end portion 65 for those occasions when the dentist may need to use saliva ejector 50 as a spotlight. FIG. 11 shows saliva ejector 50 in use. When chemiluminescent components 54 and 56 make contact, luminescence 80 is generated. Fresnel lens 67, allows luminescence 80 to be emitted from end portion 65 as well as being emitted from tube 66. Fresnel lenses are inexpensive and commonly made today out of plastic for various uses, both novelty and practical.

The chemiluminescent saliva ejector has the advantage of creating a well lit environment for performing dental procedures, while having the added benefit of saving space in an already crowded work environment. Without the addition of extra lighting components or the need for a light above shining into the patient's mouth, work space is maximized. The user no longer has to worry about blocking light from an outside source or working around a light inside the patients mouth.

One or more embodiments of the present invention have been described. Nevertheless, it will be understood that various modifications may be made without departing from the spirit and scope of the invention. Accordingly, other embodiments are within the scope of the following claims.

What is claimed is:

1. A dental appliance having an exterior wall formed from a light transmitting material; and a light source contained within said exterior wall wherein said light source is activated by a user.

2. A dental appliance as in claim 1, wherein said light source is produced by a reaction of chemiluminescent components.

3. A dental appliance as in claim 2 wherein said chemiluminescent components are contained by spaces defined by an inner surface of said exterior wall and an outer surface of an interior wall.

4. A dental appliance as in claim 1, wherein said exterior wall contains a plurality of indentations defining suctioning channels.

5. A saliva ejector comprising:
a first tube and a second tube, said second tube positioned within said first tube with a space defined by an inner diameter of a first tube and an outer diameter of a second tube;
a deformable partition separating said space into a first chamber and a second chamber;
a first chemiluminescent component contained in said first chamber; and
a second chemiluminescent component contained in said second chamber wherein, upon deformation of said deformable partition, said first and second chemiluminescent components mix to produce luminescence.

6. A saliva ejector as in claim 5, wherein a first end of said second tube is adapted to receive a vacuum attachment.

7. A saliva ejector as in claim 5, wherein a second end of said second tube is adapted to receive a suctioning tip.

8. A saliva ejector as in claim 5, wherein said first and second chemiluminescent components are nontoxic to humans.

9. A saliva ejector as in claim 8, wherein said first chemiluminescent component is a phenyl oxalate ester solution and said second chemiluminescent component is hydrogen peroxide.

10. A saliva ejector as in claim 5, wherein said first tube is effective to transmit light.

11. A saliva ejector as in claim 10, wherein said first tube is selected from the group consisting of polyethylene, polypropylene and polycarbonate.

12. A saliva ejector as in claim 5, wherein both said first tube and said second tube are flexible.

13. A saliva ejector as in claim 12, wherein both first tube and said second tube are semi-rigid polyvinyl chloride.

14. A method for illuminating an oral cavity, the method comprising:
bending the chemiluminescent saliva ejector of claim 5, thereby deforming said deformable partition;
mixing said first and second chemiluminescent components to produce luminescence; and
inserting said chemiluminescent saliva ejector into an oral cavity to illuminate said oral cavity.

15. A chemiluminescent saliva ejector comprising:
an exterior tube having a first end adapted to receive a suctioning tip and a second end adapted to receive a vacuuming attachment, wherein said exterior tube comprises a plurality of indentations on an inner surface;
a container positioned within said exterior tube; and
suctioning channels defined by a plurality of indentations, wherein said indentation are located on one of an inner surface of said exterior tube, an outer surface of said container or a combination thereof.

16. A chemiluminescent saliva ejector as in claim 15, wherein a vial is stored within said container; said vial containing chemiluminescent components.

17. A chemiluminescent saliva ejector comprising:
a container disposed in a first end of a tube, wherein said container includes a first compartment and a second compartment; and
a first chemiluminescent component contained in said first compartment and a second chemiluminescent component contained in said second compartment, wherein upon bending of said container said chemiluminescent components mix to produce luminescence.

18. A chemiluminescent saliva ejector as in claim 17, wherein said first compartment and said second compartment are formed by a deformable partition.

19. A chemiluminescent saliva ejector as in claim 17, wherein said second compartment is a glass vial.
